(19) United States
(12) Patent Application Publication
(10) Pub. No.: US 2010/0240339 A1
(43) Pub. Date: Sep. 23, 2010

(54) COMMUNICATION SYSTEM AND DEVICE PROVIDING ALERT WARNINGS AND METHOD THEREFOR

(75) Inventor: HARRY DIAMOND, TIPTON, IN (US)

Correspondence Address: DELPHI TECHNOLOGIES, INC, M/C 480-410-202, PO BOX 5052, TROY, MI, 48007, US

(73) Assignee: DELPHI TECHNOLOGIES, INC., TROY, MI (US)

(21) Appl. No.: 12/491,542

(22) Filed: Jun. 25, 2009

Related U.S. Application Data
(60) Provisional application No. 61/161,261, filed on Mar. 18, 2009.

(51) Int. Cl. H04M 11/04

(52) U.S. Cl. 455/404.2

(57) ABSTRACT

A communication system is provided that includes a cellular phone communication device in communication with a cellular phone service provider having a remote server. The communication device includes a device for determining a current position and a transceiver for transmitting at least one of the determined current position and geographic identifier to the remote server. The communication device further receives at least one of a geographic identifier and alert information relevant to the determined position from the server and includes an output for outputting alert information relevant to the determined position.

### CROSS-REFERENCE TO RELATED APPLICATION

This application claims priority under 35 U.S.C. § 119(e) to U.S. Provisional Patent Application No. 61/161,261, filed on Mar. 18, 2009, the entire disclosure of which is hereby incorporated herein by reference.

### TECHNICAL FIELD

The present invention generally relates to electronic communication devices and, more particularly, relates to a communication device for providing messages such as emergency or alert messages and other information.

### BACKGROUND OF THE INVENTION

The National Oceanic and Atmospheric Administration (NOAA) has been providing a weather band radio broadcast service in the United States for many years. The NOAA weather radio (NWR) service provides continuous weather and emergency related updates to local geographic regions. The NOAA weather radio service provides weather-related warnings and serves as a broadcast warning system for other emergency messages about events that may threaten life and/or property. To receive weather band broadcast service information, typically a dedicated receiver is generally required to tune to the weather band broadcast.

Traditionally, the NOAA weather band broadcast transmissions have operated on seven narrow band frequency modulated (FM) channels in the very high frequency (VHF) band ranging from 162.400 to 162.550 kHz, with a 25 kHz channel separation between adjacent channels. The seven channels are broadcast from transmitters located in various geographic regions and the signals for multiple channels often overlap. Accordingly, it is often possible to tune a weather band radio to receive a plurality of weather band channels from one location.

The NOAA weather service broadcast also includes digital voice synthesis which allows for faster distribution of emergency updates, in contrast to analog voice recordings or live voice. Moreover, NOAA also employs Specific Area Message Encoding (SAME) which provides digital information indicative of the geographic region covered by the accompanying message. Currently, the geographic regions are typically defined by counties. This allows for weather band receivers to filter out messages that do not pertain to a selected geographic region. In general, the NOAA weather radio transmitter devoted to a given geographic area may not provide the strongest signal with the best reception that is available at certain locations in its coverage area. As a consequence, by simply tuning to the station having the strongest signal, a radio user may miss those messages pertaining to the geographic region of interest.

The use of the SAME message generally allows for receipt of only those messages in a selected geographic area. The weather band radio generally includes decoding circuitry capable of decoding the SAME digital message. In addition, a geographic identification code generally is used to identify the county of interest and, in many radios, the code must be manually input into the decoding circuitry to configure the radio for the geographic area of interest. Once configured, the weather band radio will respond only to those messages associated with the selected geographic identification code, and may ignore alert messages which do not pertain to the selected region of interest. For fixed location radios such as conventional home-based weather band radios, the SAME message is generally satisfactory since the location of the radio is typically fixed. However, when the weather band radio is transported from one geographic coverage region to another geographic coverage region, the weather band radio generally must be reprogrammed by the user. This reprogramming drawback becomes particularly significant when a weather band radio is used in a mobile vehicle, such as an automobile, which frequently travels amongst various geographic counties.

An approach that addresses the aforementioned drawback is disclosed in U.S. Pat. No. 6,526,268, titled Mobile Weather Band Radio and Method. The aforementioned patent discloses a radio employing a position determining device, such as GPS, and uses the determined position to determine a geographic region identifier. The determined geographic identifier is compared to SAME Message identifiers to acquire and output those messages that pertain to the current geographic region even as the radio moves from one region to another region.

It is desirable to provide for further enhancements to alert warning messaging services, particularly for mobile applications.

### SUMMARY OF THE INVENTION

In accordance with one aspect of the present invention, a communication device is provided for providing alert information. The communication device includes a device for determining a current position. The communication device also includes a transceiver for transmitting at least one of the determined current position and a geographic identifier to a remote server and for receiving at least one of a geographic identifier and alert information relevant to the determined position from the server. The communication device further includes an output for outputting alert information relevant to the determined position.

According to another aspect of the present invention, a communication system is provided. The system includes a server, a communication link and a communication device in communication with the server via the communication link. The communication device provides alert message outputs. The communication device includes a device for determining a current position. The communication device also includes a transceiver for transmitting at least one of the determined current position and a geographic identifier to the remote server and for receiving at least one of a geographic identifier and alert information relevant to the determined position from the server. The communication device further includes an output for outputting alert information relevant to the determined position.

According to a further aspect of the present invention, a method of providing alert messages with dynamic geographic updating is provided. The method includes the steps of determining a current position of a communication device. The method also includes the steps of transmitting at least one of the determined current position and a geographic identifier to a server remote from the communication device. The method further includes the step of comparing the current position with electronically stored map data and determining which one of a plurality of geographic regions the current position is located within. The method further includes the steps of transmitting at least one of a geographic identifier and alert information relevant to the determined position from the server to the communication device and outputting alert information relevant to the determined position by way of the communication device.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a schematic diagram illustrating a communication system including a cellular phone and a phone service provider for providing alert information to the cellular phone user, according to one embodiment;

FIG. 2 is a block diagram further illustrating the communication system, according to one embodiment;

FIG. 3 is a map illustrating one example of geographic county regions electronically stored and used in the communication system;

FIG. 4 is a flow diagram illustrating a method of providing geographic based alert messages to the cellular phone, according to a first embodiment;

FIG. 5 is a flow diagram illustrating a method of providing geographic based alert messages to the cellular phone, according to a second embodiment;

FIG. 6 is a flow diagram illustrating a method of providing geographic based alert messages to the cellular phone, according to a third embodiment; and

FIGS. 7A and 7B are a flow diagram illustrating a method of providing a geographic based alert messages to the cellular phone, according to a fourth embodiment.

### DESCRIPTION OF THE PREFERRED EMBODIMENTS

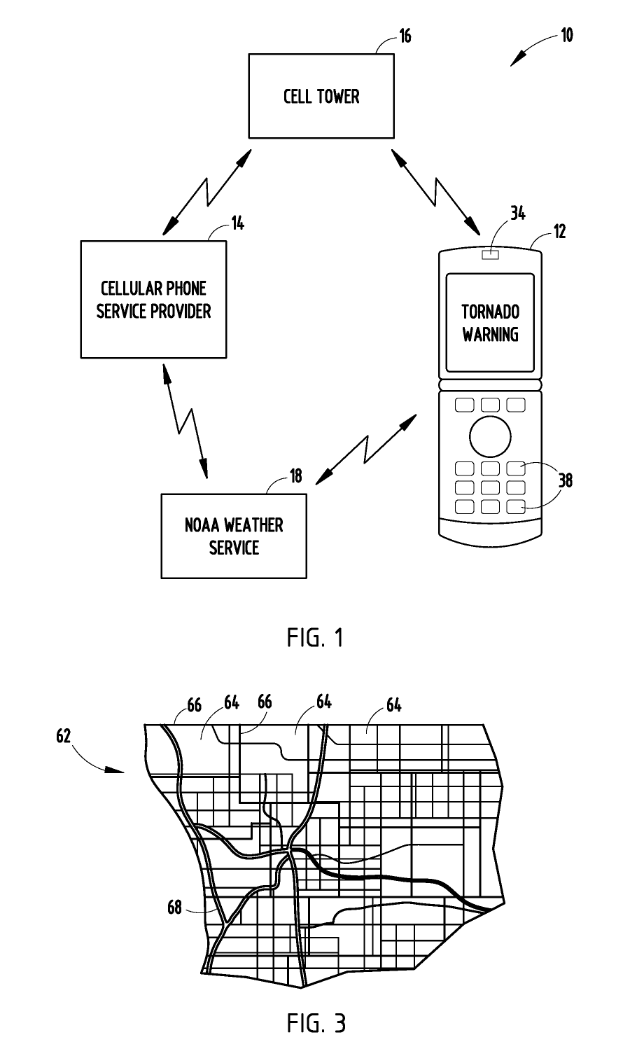

Referring to FIG. 1, a communication system 10 is generally shown including a mobile electronic communication device, shown and described herein as a cellular phone 12, according to one embodiment, in communication with a cellular phone service provider 14. The cell phone 12 communicates with the service provider 14 via a network of one or more cell towers 16, according to one embodiment. The cellular phone 12 communicates cellular phone transmissions with the service provider 14, and further communicates with the service provider 14 to provide alert messages, such as those made available by NOAA weather service, to a cell phone user. The communication device 12 may include devices other than a cellular phone, such as navigation devices, computers, and other devices that have signal communications. It should be appreciated that the electronic communication device 12 and service provider 14 may otherwise communicate via satellite communications, direct signal communications, land line communications and combinations of known signal communications.

At least one of the service provider 14 and communication device 12 further communicates with an alert message provider, shown and described herein as the NOAA weather service 18, to receive weather service messages including SAME messages and the associated alert messages. The communication device 12 may receive the alert messages using a weather band radio, according to one embodiment. The service provider 14 may receive the alert messages using a weather band radio, according to one embodiment. According to another embodiment, the service provider 14 may receive the alert messages by way of a network connection to the weather service 18, such as via an internet connection.

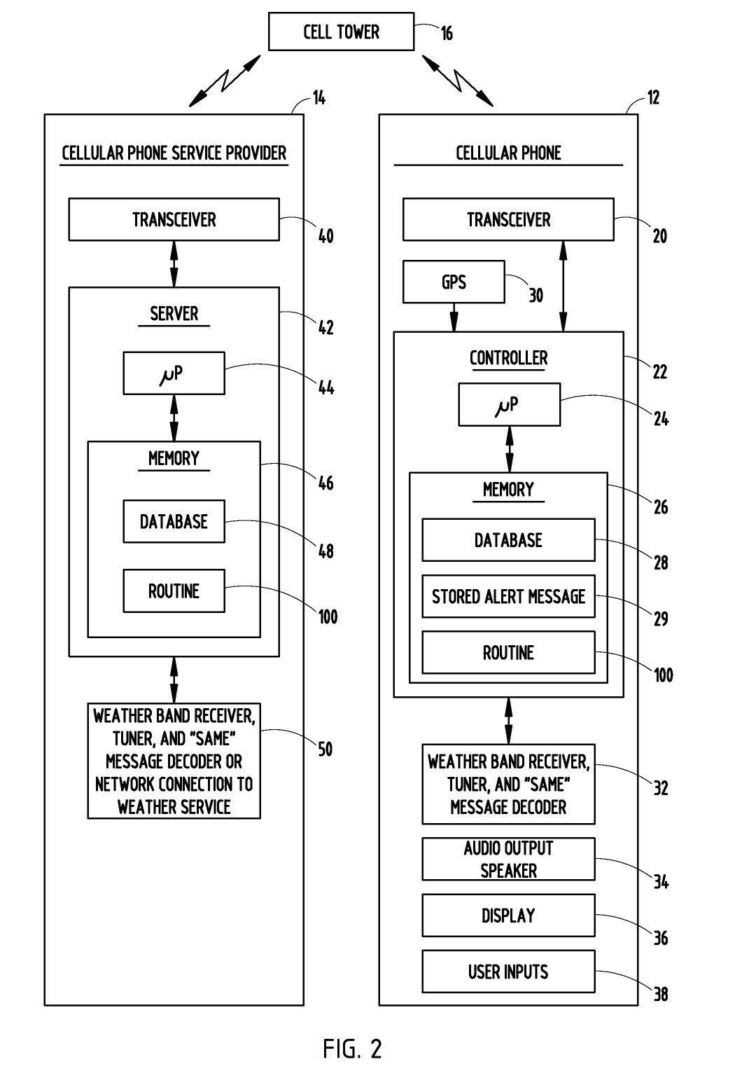

Referring to FIG. 2, the cellular phone communication device 12 is further illustrated employing a transceiver 20 for providing two-way signal communication. The transceiver 20 may include a conventional cellular phone transceiver and antenna (not shown) for transmitting and receiving cellular signals. The transceiver 20 further communicates information that allows for alert messages to be provided to the communication device 12 that pertain to the geographic region relevant to the communication device 12.

The communication device 12 is also shown employing a device for determining current position which, according to one embodiment, is shown and described herein as a global positioning system (GPS) receiver 30. According to well-known GPS operations, the GPS receiver 30 receives GPS radio wave signals via a GPS receiving antenna (not shown). The GPS radio wave signals are emitted from existing GPS satellites. A constellation of multiple high altitude GPS satellites currently exist in earth orbit and are available to provide continuous worldwide position fixes in all types of weather conditions. The GPS receiver 30 may have a built-in processing unit and memory for processing the GPS radio wave signals to determine the latitude and longitude position coordinates of the current position, as well as determining the current direction of travel and speed.

More specifically, the GPS receiver 30 continuously receives radio wave signals from the GPS antenna and determines accurate position coordinates which identify the location of the received signals. This determination includes calculating the distance from various satellites to determine a position relative thereto. By measuring the current signals sent by the GPS satellites and knowing orbital parameters of the satellites, the GPS receiver 30 is able to determine the position thereof and generate longitude and latitude position coordinates which identify the position of the received signals. Given the received GPS signals, the latitude and longitude position coordinates of the GPS receiver 30 are determined by computing distance from each of several GPS satellites currently visible to the receiver 30 by direct-line-of-sight. Distance is determined by precise computation of the time required for radio signals to travel from the GPS satellite to the GPS receiver 30. Combined with precise information about the satellites' positions relative to the earth, precise latitude and longitude position coordinates are computed. GPS is widely known and should be understood to those skilled in the art as a means for providing accurate position information. It should also be understood that enhanced accuracy may be obtained with GPS now and in the future. Further, it should be appreciated that other forms of position determining devices, other than GPS, could be employed now and in the future to provide updated position information.

The cellular phone communication device 12 is further shown having control circuitry, shown as a controller 22, for controlling signal transmission and reception, processing data and executing one or more routines. The controller 22 includes a microprocessor 24 and memory 26, according to one embodiment. The memory 26 may include flash memory, according to one embodiment, or other volatile or non-volatile memory storage according to other embodiments. Stored in memory 26 is a database 28 which may contain geographic region identifiers, according to one embodiment. It should be appreciated that the server 42 may provide updates to the database 28, particularly when data is stored locally on the cellular phone communication device 12. Also stored in memory 26 are stored alert messages 29 which may be replayed as output to a user, particularly if earlier message outputs may have not been noticed by a user and may be periodically reviewed for time and/or geographic relevance. One or more routines 100 are also stored in memory 26 and are executable by the microprocessor 24 to provide alert messages.

The cellular phone communication device 12 is shown having a weather band radio 32 provided therein, according to one embodiment. The weather band radio 32 may include a dedicated weather band receiver or may be integrated into the phone electronics to provide for receipt of weather band signals that are broadcast within a geographic region of interest. The weather band radio 32 generally includes an antenna (not shown), a receiver, a tuner, and a decoder. The weather band radio 32 is capable of receiving signals broadcast in the weather band frequency range, and may receive signals in other radio bands as well. Examples of weather band radios that may be employed as weather band radio 32 are disclosed in U.S. Pat. No. 6,526,268 and U.S. Pat. No. 6,728,522, the entire disclosures of which are hereby incorporated herein by reference. Alternately, the cellular phone communication device 12 may connect to the weather station via an internet cellular phone communication signal.

The weather band radio tuner may be automatically adjustable via the controller 22 to tune to one of a plurality of available weather band channels for receiving broadcast weather band signals which may contain weather, emergency or other messages. Weather band tuners are commercially available and are well-known in the art for receiving broadcast narrow band FM signals provided throughout the United States by the National Oceanic and Atmospheric Administration (NOAA) weather radio (NWR) service. Currently, the NOAA weather radio service transmits seven weather band channels in the very high frequency range of 162.400 to 162.550 kHz, having a 25 kHz channel spacing between adjacent channels. The weather band radio tuner is adjustable in that it can be adjusted to tune to any one of the channels that are made available. The server 42 may transmit the appropriate frequency to the communication device 12 based on the geographic location, according to one embodiment.

The NOAA weather radio service currently transmits weather and emergency related message information on the weather band, and provides an emergency alert system in which weather and emergency messages are broadcast, along with other information, as part of the specific area message encoding (SAME) message. The SAME message further includes one or more geographic identifiers, generally in the form of alphanumeric codes, which define the geographical counties to which the weather or emergency information pertains. Currently, each geographic identification code corresponds to a unique county, however, other geographical boundaries may be defined and assigned a unique code. A description of one example of the specific area message encoding and listing of the available warning alert data provided by the NOAA weather radio service is disclosed in the published report entitled “NOAA WEATHER RADIO ALL HAZARDS (NWR) SPECIFIC AREA MESSAGE ENCODING (SAME),” National Weather Service Instruction 10-1712, dated Feb. 17, 2006, which is hereby incorporated herein by reference.

According to one embodiment, the weather band radio's SAME message decoder receives and decodes the SAME message received by the weather band radio tuner, and provides the decoded message to the controller 22. The controller 22 processes the SAME message, along with GPS received position information and, in accordance with the programmed software stored in flash memory 26 or other memory, actuates the appropriate response for the geographical region(s) of interest by outputting the alert message. According to one embodiment, the weather and/or emergency message information is made available for the county where the phone 12 is currently located. According to another embodiment, the predicted nearby (e.g., upcoming) county and/or surrounding counties and/or counties along a planned travel route are included.

The cellular phone 12 is further shown including user inputs 38 which may include user actuated push buttons and/or touch-screen inputs and/or voice recognized commands. The cellular phone 12 also includes a display 36 which provides a visual output and may further provide the touch-screen inputs. The display 36 may display alert messages as outputs to a user. Additionally, the cellular phone 12 has an audio output speaker 34 which may provide audible alert messages to the user as output(s).

The cellular phone service provider 14 is shown having a transceiver 40 which may communicate with one or more cell towers 16 to communicate with other devices including the cellular phone 12. It should be appreciated that the transceiver 40 may be located in each of the cell towers 16 and the provider 14 may communicate with the cell towers 16 via wire connections. Service provider 14 also includes a server 42 shown having a microprocessor 44 and memory 46. The server 42 essentially is a controller that serves to manage the communications with a plurality of devices including one or more cellular phones and other communication devices. The memory 46 may include a hard drive, or other memory. Stored within memory 46 is a database 48 which may provide the NOAA county codes and map data, according to one embodiment. Also stored in memory 46 are one or more routines executable by the microprocessor 44 for enabling execution of at least a portion of the alert messaging routine. The service provider 14 may further store tracked alert messages in memory 46 and may monitor when the communication device 12 is turned off or otherwise unavailable, such that the stored alert messages may be transmitted to the communication device when the device 12 is turned back on or otherwise made available or may further query the communication device to determine if the device 12 would like to receive any stored alert messages.

The cellular phone service provider 14 is further shown employing a weather band radio 50 which may include one or a plurality of a receiver, tuner, and “SAME” message decoder or network connection to the weather service with a plurality of receivers, the receivers may be remotely located. According to one embodiment, the weather band radio 50 may receive one or more NOAA weather band broadcasts similar to the operation as described in connection with the weather band radio 32. According to another embodiment, the weather band radio 50 may take the form of an internet or intranet connection to the weather service, such as an internet connection to receive alert messages. The alert messages may then be provided to the communication device 12 and output by device 12 to a user when such messages are relevant to the determined position of the communication device 12.

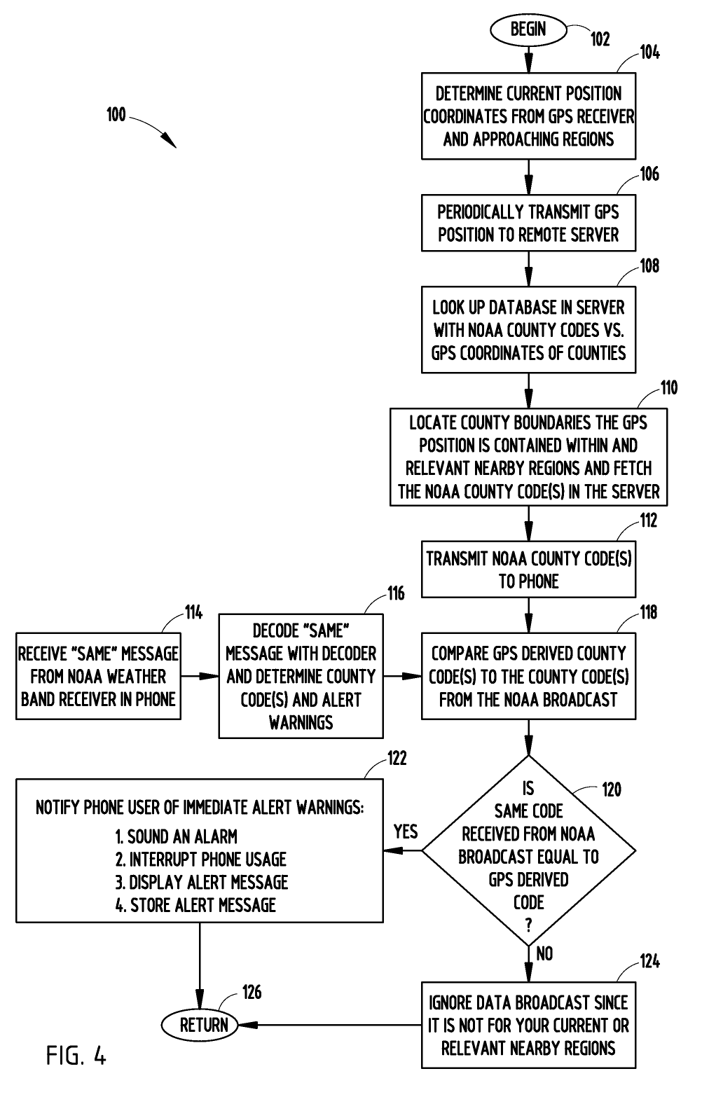

Geographic regions are electronically mapped and stored in memory 26 and/or memory 46 as respective database 28 and/or database 48 along with geographic identification codes that identify each of the regions. An example of a geographic territory and the boundaries defining each county as the geographic regions is shown in FIG. 3. The solid lines 66 represent the geographic boundaries defining each of a plurality of counties 64. As the communication device 12 moves, such as, for example, by travel in a vehicle on a road 68, the device 12 may cross geographic boundaries 66 to travel from one county to another county. Each of the counties 64 has an assigned geographic identification code stored in memory. The longitude and latitude position coordinates of the boundaries may be stored in memory and compared to the GPS derived current position to determine the geographic region of interest.

According to one embodiment, the communication device 12 determines the current geographic position by way of the GPS receiver 30 and provides the current determined position to the cellular phone service provider 14 by way of a cellular signal. The cellular phone service provider 14 compares the determined current position to the NOAA weather band county codes to determine which county code is relevant to the determined current position. The relevant NOAA county code is then transmitted back to the cellular phone 12 by way of cellular signals so that the cellular phone communication device 12 may receive weather band alert messages and determine which messages are relevant based on the determined county code and provide an output alert message when the alert message pertains to the current geographic position.

According to another embodiment, the cellular phone communication device 12 determines the current position via the GPS receiver 30 and uploads the current position to the cellular phone service provider 14 by way of cellular signals. The cellular phone service provider 14 determines the NOAA county code applicable to the determined position of the cellular phone communication device 12 and further receives the weather alert messages, decodes the messages, and acquires the messages that are relevant to the geographic area relevant to the cellular phone communication device 12. The alert messages that are relevant to the location of the cellular phone communication device 12 are then transmitted by cellular signal to the cellular phone communication device 12 so that the cellular phone communication device 12 may output the alert messages to a user which would alleviate the need for an on board weather band receiver 32 while providing similar functionality to embodiments that use on board weather band receiver 32. It should further be appreciated that the alert messages may be provided not only for the current position of the communication device 12, but may also be provided for nearby (e.g., approaching or surrounding) geographic regions. It should further be appreciated that other geographically defined regions may be employed such as defining boundaries based on rectilinear coordinates, based on radial distance from a point, or based on distance from a certain location such as a county seat, without departing from the teachings of the present invention.

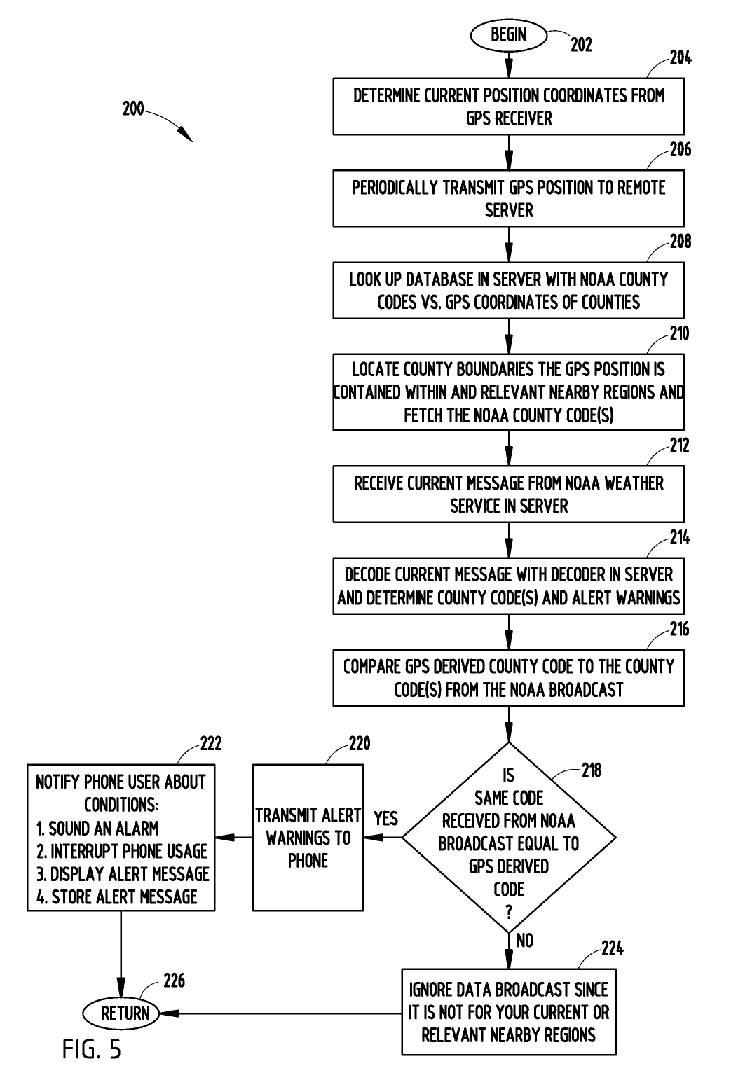

Referring to FIG. 4, a methodology 100 is shown for providing alert messaging services for a cellular phone communication device, according to a first embodiment. Methodology 100 begins at step 102 and proceeds to step 104 to determine the current position coordinates from the GPS receiver. Next, in step 106, methodology 100 periodically transmits the GPS position to a remote server. The remote server may be provided in a cellular phone service provider. Next, methodology 100 proceeds to step 108 to lookup a database in the server with NOAA county codes versus GPS coordinates of counties. In step 110, methodology 100 locates the county boundaries that the GPS position is contained within and relevant nearby regions and fetches the corresponding NOAA county code(s) in the server. The NOAA county code(s) are then transmitted to the cellular phone communication device in step 112. Accordingly, the NOAA county code(s), which identifies the geographic region that includes the current position coordinates, is determined in the server and transmitted to the cellular phone. In addition, the server may also transmit the appropriate weather band frequency to the cellular phone, which may advantageously allow the phone to tune to the most relevant weather band channel. The additional transmission of the appropriate weather band frequency is particularly advantageous when the weather radio in the phone does not scan the weather band frequencies to determine the most relevant frequency.

At the same time, methodology 100 receives the SAME message from the NOAA weather band receiver located in the cellular phone communication device in step 114. The weather band receiver in the communication device may scan the weather band frequencies looking for all broadcast SAME messages. The weather band receiver may continuously monitor the weather band or may intermittently or periodically monitor the weather band for SAME messages. In step 116, methodology 100 decodes the SAME message with the weather band radio decoder and determines county code(s) and alert warnings. The decoded message may include weather, emergency or other alert information. Additionally, the decoder message includes one or more county code identifiers which identify the county, portions of the county, a plurality of counties for which the associated weather emergency or other message information pertains. Next, in step 118, methodology 100 compares the GPS derived county code to the county code(s) from the SAME message of the NOAA broadcast in the phone. Decision block 120 then compares the SAME county code received from the NOAA broadcast with the GPS derived county code in the phone, and determines if the county codes match. If the SAME county code does not match the GPS derived code, the NOAA broadcast message is ignored in step 124, since the message does not pertain to the current or relevant nearby regions in which the communication device is located. If the SAME county code matches the GPS derived county code, methodology 100 proceeds to step 122 to notify the user of immediate alert messages, such as warnings. The alert messages may include providing various features such as sounding an audible alarm, interrupting phone usage, displaying alert messages, and storing alert messages in memory to be replayed, amongst other warning outputs. The alert messages could include the warning of a severe weather condition, such as a tornado watch or a tornado warning, and/or a statement of a condition or emergency regarding non-weather related information. Following each of steps 122 and 124, methodology 100 returns at step 126 to repeat the steps.

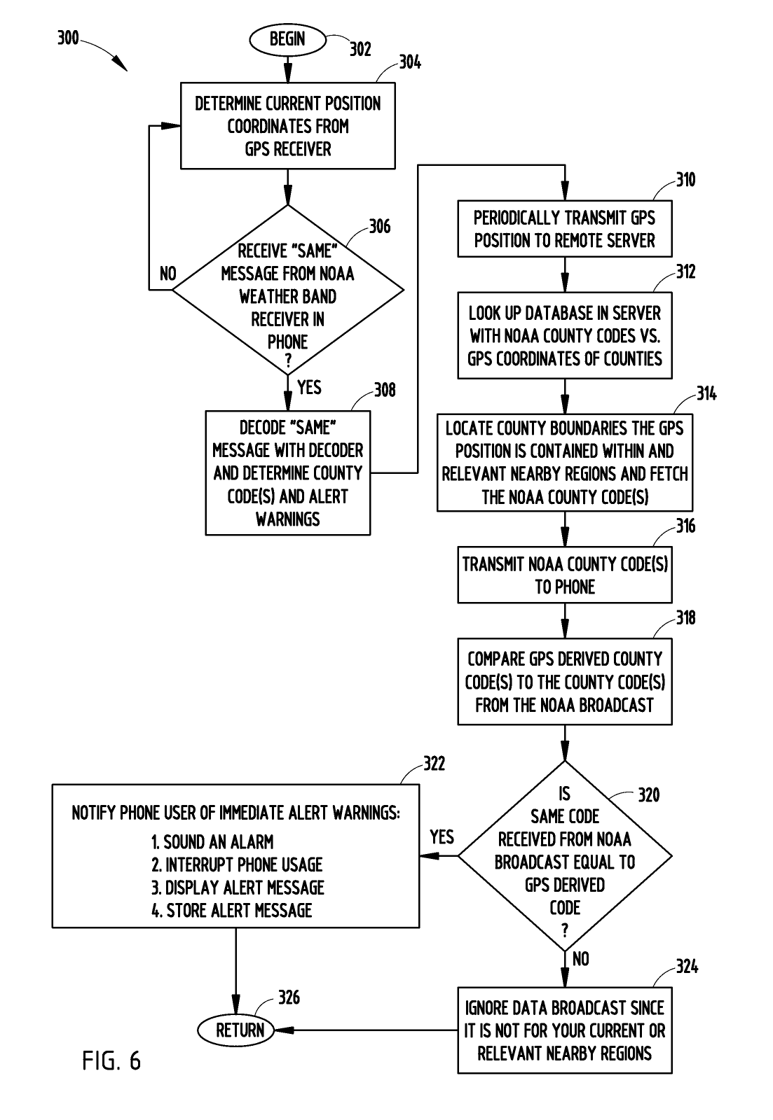

Referring to FIG. 5, methodology 200 is shown for providing alert message services to a cellular phone communication device, according to a second embodiment. Methodology 200 begins at step 202 and proceeds to step 204 to determine the current position coordinates from the GPS receiver located within the cellular phone communication device. Next, at step 206, the cellular phone communication device periodically transmits the GPS position to a remote server, such as the cellular phone service provider. Methodology 200 looks up a database in the server with the NOAA county codes versus GPS coordinates of counties in step 208. Next, in step 210, methodology 200 locates county boundaries that the GPS position is contained within and relevant nearby regions and fetches the corresponding NOAA county code(s). In this embodiment, methodology 200 receives the current message from the NOAA weather service via the server in step 212. In step 214, methodology 200 decodes the current message with a decoder in the server and determines the county code(s) and alert warnings in the server. Methodology 200 then proceeds to step 216 to compare the GPS derived county code(s) to the county code(s) from the NOAA broadcast in the server. Decision block 218 then compares the SAME county code received from the NOAA broadcast with the GPS derived county code in the server, and determines if the county codes match. If the SAME county code does not match the GPS derived code, the NOAA broadcast message is ignored in step 224, since the message does not pertain to the geographic region in which the communication device is located. If the SAME county code matches the GPS derived code, methodology 200 proceeds to step 220 to transmit alert warnings from the server to the cellular phone communication device, which may occur by cellular signal transmissions. When the communication device receives the transmitted alert warnings, method 200 proceeds to step 222 to notify the phone user about the alert message conditions. The notification may include sounding an alarm, interrupting phone usage, displaying alert messages, and storing alert messages for later playback, amongst other possible actions. Following each of steps 222 and 224, methodology 200 returns at step 226 to repeat the above steps.

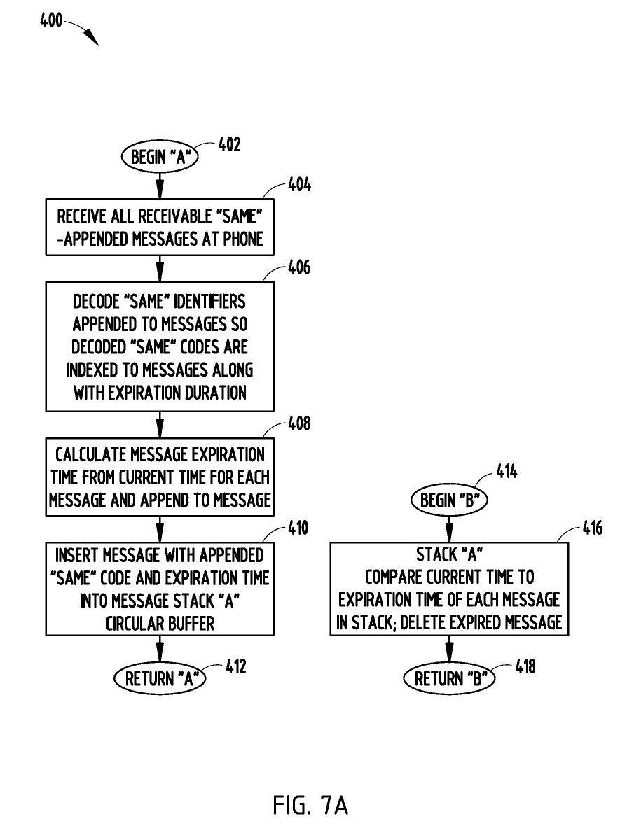

Referring to FIG. 6, a methodology 300 for providing alert message services to a communication device is provided, according to a third embodiment. Methodology 300 begins at step 302 and proceeds to step 304 to determine the current position coordinates from the GPS receiver. In decision step 306, methodology 300 checks to see whether the SAME message has been received from NOAA weather band receiver in the cellular phone communication device. If the SAME message has not been received, methodology 300 returns to step 304. If the SAME message has been received, methodology 300 proceeds to step 308 to decode the SAME message with a decoder in the phone and to determine the county code(s) and alert warnings from the decoded message. Methodology 300 then proceeds to step 310 to periodically transmit the GPS position from the phone to the remote server. Accordingly, the receipt of SAME messages triggers the transmission of the GPS position coordinates to the remote server from the cellular phone communication device.

In the server, a database is looked up with the NOAA county codes versus the GPS coordinates of counties at step 312. Proceeding to step 314, methodology 300 locates county boundaries the GPS position is contained within and relevant nearby regions and fetches the corresponding NOAA county code(s) in the server. The NOAA county code(s) are then transmitted from the server to the cellular phone communication device at step 316. At step 318, methodology 300 compares the GPS derived county code(s) to the county code(s) from the NOAA broadcast via the phone. Decision block 320 then compares the SAME county code received from the NOAA broadcast with the GPS derived county code, and determines if the county code(s) match in the phone. If the SAME county code does not match the GPS derived code, the NOAA broadcast message is ignored in step 324, since the message does not pertain to the geographic region in which the communication device is located. If the SAME county code matches the GPS derived county code, methodology 300 proceeds to step 322 to notify the cellular phone user of immediate alert message such as warnings. The immediate alert warnings may include sounding an alarm, interrupting phone usage, displaying alert messages, storing alert messages for playback amongst other actions. Following each of steps 322 and 324, methodology 300 returns at step 326 to repeat the above steps.

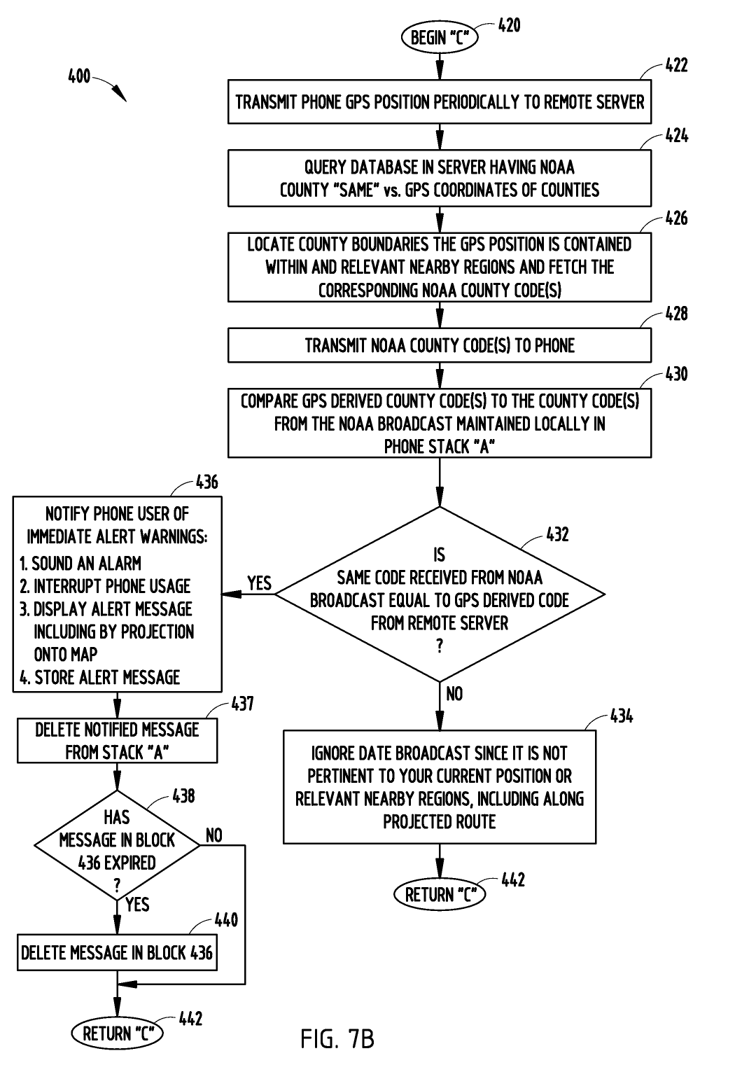

Referring to FIGS. 7A and 7B, a methodology 400 is shown for providing alert messaging services for a cellular phone communication device, according to a fourth embodiment. Methodology 400 essentially includes routine A which begins at step 402, routine B which begins at step 414 and routine C which begins at step 420, all of which are simultaneously executable and repeated independent of each other. Routine A of methodology 400 proceeds to step 404 to receive all receivable SAME appended messages at the cellular phone. In step 406, methodology 400 decodes the SAME identifiers appended to messages so decoded SAME codes are indexed to messages along with expiration duration. Proceeding to step 408, methodology 400 calculates the message expiration time from the current time for each message and appends the expiration time to the message. Routine 400 then inserts the message with the appended SAME code and expiration time into a message stack A, which essentially is a circular buffer in step 410 and returns to the beginning of routine A at step 412.

The stack A circular buffer is essentially made available for routine B which begins at step 414 and proceeds to step 416 to compare the current time to the expiration time of each message in the stack A, and deletes any expired messages. Routine B returns to the beginning at step 418 and is therefore essentially repeated to purge expired messages from the circular buffer.

The up-to-date buffer with expired messages purged is then made available to routine C which begins at step 420. Methodology 400 proceeds to step 422 to transmit the cellular phone GPS position periodically to the remote server. In the server, methodology 400 queries the database having the NOAA county SAME versus GPS coordinates of the counties at step 424. At step 426, methodology 400 locates the county boundaries that the GPS position is contained within and relevant nearby regions and fetches the corresponding NOAA county code(s). In step 428, methodology 400 transmits the NOAA county code(s) to the phone. Methodology 400 then compares the GPS derived county code(s) to the county code(s) from the NOAA broadcast maintained locally in the cellular phone stack A at step 430. Decision step 432 then compares the SAME county code received from the NOAA broadcast to see if it is equal to the GPS derived code from the remote server. If the codes do not match, methodology 400 proceeds to step 434 to ignore the database broadcast since it is not pertinent to the current position or relevant nearby regions, including along a projected route, and then returns at step 442. If the SAME county code matches the GPS derived county code, methodology 400 proceeds to step 436 to notify the phone user of immediate alert warnings. The alert warnings may include sounding an audible alarm, interrupting phone usage, displaying alert messages including by projecting a message onto a map, and storing alert messages in memory to be replayed, amongst other warning outputs. Thereafter, routine 400 deletes the notified message from stack A in step 437 to prevent repeating notification. Next, routine 400 proceeds to decision step 438 to determine if the notified message in block 436 has expired in time and, if so, deletes the notified message in block 436 at step 440. If the message has not expired, the message is maintained and methodology 440 proceeds to step 442 to return to the beginning of routine C. It should further be understood that routine 400 may alternately apply a hysteresis function based on location and/or time that could be used instead of step 437 to prevent excessive repeating notifications.

Accordingly, the communication system employs a communication device 12 that communicates information to a remote server, and the remote server provides information back to the communication device to enable the outputting of alert messages relevant to the location of the communication device. In one embodiment, the communication device transmits the determined position information to the remote server, the remote server determines the geographic county code and transmits the county code back to the communication device 12, and the communication device 12 determines the alert messages that are relevant to the corresponding county code and outputs those messages. According to another embodiment, the communication device 12 transmits a determined position information to the server, the server determines the corresponding county code and further determines the alert message relevant to the determined county code and transmits the alert message to the communication device 12 so that the communication device 12 may output the alert messages. It should further be appreciated that other information may be transmitted between the communication device 12 and the server according to other embodiments. According to a further embodiment, the communication device 12 may determine the NOAA county code from the database in the device 12 and may transmit the determined county code to the remote server, the remote server may then receive the SAME messages and determine the alert messages relevant to the determined county code and may transmit the alert messages to the communication device 12 which may then output the messages to a user.

It should further be appreciated that the communication device 12 and communication system described herein may advantageously provide alert messages relevant to the regions of interest relevant to the usage of the communication device. The messages may pertain to regions in which the communication device is located, nearby regions, regions the communication device is expected to be approaching, and other regions relevant to the location of the communication device. It should further be appreciated that the alert messages may have an expiration time such that the alert message is output only as long as the expiration time has not yet expired.

Accordingly, the communication device 12 and communication system advantageously provides for alert messaging services that pertain to the geographic region of interest. The advantageously allows for the receipt of alert messages that pertain to the geographic position of the communication device, and may ignore messages that do not pertain to the current geographic position.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A communication device for providing alert information, said device comprising:
a device for determining a current position;
a transceiver for transmitting at least one of the determined current position and a geographic identifier to a remote server and for receiving at least one of a geographic identifier and alert information relevant to the determined position from the server; and
an output for outputting alert information relevant to the determined position.

2. The communication device as defined in claim 1, wherein the communication device comprises a weather band radio receiver for receiving weather band station signals.

3. The communication device as defined in claim 1, wherein the communication device comprises a portable handheld device.

4. The communication device as defined in claim 1, wherein the communication device comprises a phone.

5. The communication device as defined in claim 1, wherein the device for determining a current position comprises a position indicative receiver for receiving position indicative signals.

6. The communication device as defined in claim 5, wherein the position indicative receiver comprises a global positioning system receiver for receiving global positioning system signals.

7. The communication device as defined in claim 1, wherein the server comprises a plurality of geographic identifiers and an electronic map data defining geographic regions corresponding to the geographic identifiers, wherein the server processes the determined current position to determine one of the graphic identifiers corresponding to the determined current position and generates an alert message for transmission to the communication device.

8. The communication device as defined in claim 1, wherein the communication device receives a determined geographic identifier from the server and outputs an alert message relevant to the determined geographic position.

9. The communication device as defined in claim 1, wherein the communication device comprises a navigation device.

10. A communication system comprising:
a server;
a communication link; and
a communication device in communication with the server via the communication link, said communication device providing alert message outputs, said communication device comprising:
a device for determining a current position;
a transceiver for transmitting at least one of the determined current position and a geographic identifier to the server and for receiving at least one of a geographic identifier and alert information relevant to the determined position from the server; and
an output for outputting alert information relevant to the determined position.

11. The communication system as defined in claim 10, wherein the communication device comprises a phone.

12. The communication system as defined in claim 10, wherein the communication device comprises a weather band radio receiver for receiving weather band station signals.

13. The communication system as defined in claim 10, wherein the device for determining current position comprises a position indicative receiver for receiving position indicative signals.

14. The communication system as defined in claim 13, wherein the position indicative receiver comprises a global position system receiver for receiving global positioning system signals.

15. The communication system as defined in claim 10, wherein the server comprises a plurality of geographic identifiers and an electronic map data defining geographic regions corresponding to the geographic identifiers, wherein the server processes the determined current position to determine one of the graphic identifiers corresponding to the determined current position and generates an alert message for transmission to the device.

16. The communication system as defined in claim 10, wherein the communication device receives a determined geographic identifier from the server and outputs an alert message relevant to the determined geographic position.

17. A method for providing alert messages with dynamic geographic updating, said method comprising the steps of:
determining a current position of a communication device;
transmitting at least one of the determined current position and a geographic identifier to a server remote from the communication device;
comparing the current position with electronically stored map data and determining which one of a plurality of geographic regions the current position is located within;
transmitting at least one of a geographic identifier and alert information relevant to the determined position from the server to the communication device; and
outputting alert information relevant to the determined position with the communication device.

18. The method as defined in claim 17, wherein the server processes the determined current position that determines one of geographic identifiers corresponding to the determined current position and generates an alert message for transmission to the communication device.

19. The method as defined in claim 17, wherein the communication device receives a determined geographic identifier from the server and outputs an alert message relevant to the determined geographic position.

20. The method as defined in claim 17, wherein the communication device comprises a phone.

21. The method as defined in claim 17, wherein the communication device comprises a weather band radio receiver for receiving weather band station signals.
